(19) United States
(12) Patent Application Publication
(10) Pub. No.: US 2025/0262670 A1
(43) Pub. Date: Aug. 21, 2025

(54) Method and Device for Generating Control Data for a Device for Additive Manufacturing of a Component

(71) Applicant: EOS GMBH ELECTRO OPTICAL SYSTEMS, Krailling (DE)

(72) Inventors: Markus Radek, Hannover (DE); Ludger Hümmeler, Gauting (DE)

(21) Appl. No.: 18/856,573

(22) PCT Filed: Apr. 13, 2023
(86) PCT No.: PCT/EP2023/059731

§ 371 Date: Oct. 11, 2024

(30) Foreign Application Priority Data
Apr. 22, 2022 (DE) 102022109802.8

(51) Int. Cl. B22F 10/28; B22F 10/366; B29C 64/153; B33Y 10/00; B33Y 50/02

(52) U.S. Cl. CPC B22F 10/28; B22F 10/366; B29C 64/153; B33Y 10/00; B33Y 50/02

(57) ABSTRACT

Disclosed is a method for generating control data for an additive manufacturing device. The method includes obtaining or generating layer information selecting or generating a first filling region having a filling pattern of scan vectors parallel to one another with a predefined vector spacing, creating a second filling region having a filling pattern of scan vectors parallel to one another, wherein the scan vectors of the second filling region are substantially parallel to the scan vectors of the first filling region and arranged offset relative thereto, and generating control data in such a way that the device for additive manufacturing can generate component layers corresponding to the solidification regions using this control data.

The invention relates to a method and a device (“device for generating control data”) for generating irradiation control data for a device for additive manufacturing of a component in a manufacturing process in which the component is constructed in the form of component layers in a construction field by selective solidification of the building material by irradiation of the building material using at least one energy beam. The invention further relates to corresponding control data, a method for additive manufacturing of a component with such control data, a device for additive manufacturing and a control device for such a device.

Additive manufacturing processes are becoming more and more relevant in the production of prototypes and now also in series manufacture. In general, “additive manufacturing processes” are to be understood as those manufacturing processes in which a manufacturing product (“component”) is usually built up on the basis of digital 3D construction data through the deposition of material (the “building material”). The construction usually but not necessarily takes place in layers. The term “3D printing” is frequently used as a synonym for additive manufacturing, the production of models, patterns and prototypes using additive manufacturing processes is frequently designated as “rapid prototyping”, the production of tools as “rapid tooling” and the flexible production of series components is designated as “rapid manufacturing”. As mentioned initially, a central point is the selective solidification of the building material, wherein in many manufacturing processes this solidification can take place with the aid of an exposure to radiation energy, e.g. electromagnetic radiation, in particular light and/or thermal radiation but optionally using particle radiation such as electron radiation. Examples for methods operating with irradiation are “selective laser sintering” or “selective laser fusion”. In this case, thin layers of a usually powdery building material are repeatedly applied one above the other and in each layer the building material is selectively solidified in a “welding process” by spatially delimited irradiation of the locations which should pertain to the component to be manufactured after fabrication in a “welding process”, whereby the powder grains of the building material are partially or completely fused with the aid of energy introduced locally by the radiation at this location. During a cooling, these powder grains are then solidified together to form a solid. Usually in this case, the energy beam is guided along solidification tracks across the construction field and the melting or solidification of the material in the respective layer accordingly takes place in the form of “welding tracks” or “welding beads” so that ultimately a plurality of such layers formed from welding tracks is present in the component. In this way, components having very high quality and fracture strength can now be manufactured.

Preferred filling patterns for regions are hatchings. The energy beam is guided in the form of parallel tracks, which leads to the formation of a hatching of parallel welding tracks or “solidification tracks”. The hatching can consist of lines of equal length or of different lengths, e.g. in the form of a rectangle as a filling region, but with lines or solidification tracks rotated by 45° to the sides of the rectangle. Frequently, regions are also formed in the form of a checkerboard pattern made up of squares with different rotated filling patterns (which means differently rotated hatching).

To increase strength, the filling patterns of component layers lying directly on top of each other are arranged in a twisted manner. For example, in the case of a checkerboard pattern, overlapping filling patterns are twisted relative to each other. When examining the components, an increase in strength due to the twisting is certainly ascertained, but also certain heterogeneities, e.g. in the form of pores within the component structure.

It is an object of the present invention to provide a method and a device for generating control data for a device for the additive manufacturing of a component, which overcomes the disadvantages of the prior art and in particular enables an improvement in the quality of a component by improving its homogeneity, in particular for the reduction of pores (e.g. their number and/or size) or allows faster manufacture of a component whilst maintaining the same quality.

This object is achieved by a method according to claim 1, control data according to claim 10, a manufacturing method for additive manufacturing according to claim 11, a control data generation device according to claim 12, a control device according to claim 13 and a device according to claim 14.

A method according to the invention serves to generate control data for a device for the additive manufacturing of a component in a manufacturing process in which the component is constructed in a construction field in the form of component layers by selective solidification of building material by irradiating the building material with at least one energy beam.

It should be noted that the control data does not yet represent a finished component, but does represent a component since a component consists of layers of solidification tracks that have been solidified according to the control data. A component (or its component layers) corresponds to the so-called “solidification regions”. This term was selected since layers of several components can lie in a manufacturing plane, each of which must be solidified individually. Each component layer is represented by a solidification region. If several component layers are located in one manufacturing plane, they are also represented by several solidification regions.

Each solidification region in turn comprises a number of so-called “filling regions” (usually a plurality of filling regions). This term was selected because component layers frequently exhibit a complex pattern of solidification tracks. For example, the edge of a component layer is solidified differently than the inner region, wherein the inner region can in turn have several different filling patterns, e.g. with a checkerboard shape. A filling region is then a region of the solidification region with a uniform filling pattern (e.g. a specific hatching). In a checkerboard pattern, for example, the individual boxes represent filling regions. Preferably, adjacent filling regions differ by the type of their filling pattern, e.g. the orientation of the scan vectors (or “scan lines”) in space, their distance, their length or their shape. However, it can also occur that individual stripes of a hatching are viewed as separate filling patterns or that two filling regions with an identical filling pattern lie next to each other. It can also occur that a filling region encloses another filling region, e.g. an outer contour made up of parallel scan vectors (first filling region) can enclose a checkerboard-like inner region (further filling regions).

A filling region can overlap with an adjacent filling region, in which case the extent of the overlap zones can be adjustable. An overlap is usually positive, but it can also be zero or negative (distance). Overlap regions are frequently selected taking into account a dimensional difference between a scan vector in the control data and a real solidification track in an additive manufacturing process. This is due to the fact that an extension or diameter of the energy beam and a correlating curing region of a solidification track results in the latter having a width extension and can be longer than a corresponding scan vector in the control data. Thus, despite a negative overlap (distance) of scan vectors in the manufacturing, there can be a positive overlap of solidification tracks. Overlapping adjacent filling regions are compatible with the invention, since the invention takes into account the orientation of the filling regions and an overlap is irrelevant as long as the filling regions in question are themselves defined.

For an overview: a filling pattern of (mostly parallel) scan vectors represents a filling region, a solidification region is usually formed from several filling regions. During manufacture, solidification tracks are formed along the scan vectors, which are solidified into a component layer according to the filling patterns of the filling regions of a solidification region.

The method according to the invention comprises the following steps:
a) Obtaining or generating layer information comprising geometric parameters of component layers and/or information on scan vectors of solidification regions which represent component layers of the component,
b) Selecting or generating a first filling region for a first solidification region, wherein this filling region has a filling pattern of scan vectors parallel to one another with a predefined vector spacing,
c) Creating a second filling region having a filling pattern of scan vectors parallel to one another for a second solidification region lying on the first solidification region, wherein the scan vectors of the second filling region are aligned substantially parallel to the scan vectors of the first filling region and arranged offset relative thereto,
d) Generating control data in such a way that the device for additive manufacturing can generate component layers corresponding to the solidification regions using this control data.

As already indicated, in a manufacturing process in a construction field, building material is built up in layers, i.e. one after the other in several material application planes or material layers. The building material is preferably a metal powder or at least a metal-based powder. Such a powder preferably contains more than 50% by weight of metal, in particular more than 60% by weight, 70% by weight, 80% by weight or even more than 90% by weight of metal. The building material can consist of a specific pure metal or comprise alloy components. However, the invention is not restricted to this, but can also be used with other, preferably powdered, building materials, such as plastics or ceramics or mixtures of the different materials. In this case, in particular between the application of two material layers, building material is solidified (in particular selectively) by irradiating the building material with at least one energy beam generated by an irradiation unit of the manufacturing device (this means an energetic beam of photons or particles, e.g. a light beam or an electron beam). In this case, not only is the building material in the uppermost, freshly applied material layer captured and melted or remelted by the energy beam, but the energy beam usually goes a little deeper into the material bed and also reaches the underlying, already remelted material from previously applied material layers.

The layer information may be already prefabricated control data according to the prior art, in particular with regard to the first component layer, or purely geometric data of the individual component layers, in particular their shape. However, the layer information for the first component layer can also be present as control data with scan vectors and further layer information as purely geometric information for the subsequent component layers. For example, the layer information can be parallel sections of a CAD-generated component or can be based thereon.

Since solidification regions have filling regions with individual filling patterns formed from scan vectors with which material is to be solidified in the form of the component layers, they represent the component layers of the component. Thus, a solidification region pertains to a component and is not a region that is removed as intended after manufacture. It should be noted that solidification regions can also have several filling regions. Thus, a solidification region can have different filling regions at different places. The control data can comprise data on the solidification regions, i.e. not necessarily finished control data, but geometric data on the position of the scan vectors of the individual filling regions.

At least in one solidification region (specified by control data or generated in the course of the process) there is a number, in particular a plurality or even a multitude, of filling regions with a (in each case individual) filling pattern. Each solidification region is therefore formed from a number of filling regions that are to be solidified according to the scan vectors, which means that during manufacturing, building material is solidified and thereby regions with a filling pattern are formed that correspond to the filling patterns of the filling regions. The scan vectors therefore form a predefined filling pattern in each filling region, e.g. a hatching. It is important that at least some of the filling patterns (and thus also some of the filling regions) have scan vectors that are parallel to each other with a predefined vector spacing, e.g. a hatching, an arrangement of concentric circles or a contour made up of several parallel lines.

In the sense of the invention, the term “parallel” does not necessarily relate to the aligned position of straight lines, but can also refer to curved lines. For example, the lines of concentric circles within the meaning of the invention would also be parallel to each other. It should be noted that in practice, curved structures are frequently formed with scan vectors that are inherently straight. However, curved scan vectors that are laterally adjacent and uniformly spaced from one another would also be parallel to one another within the meaning of the invention. In summary, “parallel” initially simply means that the lines, especially straight lines, run in the same direction.

The scan vectors have a certain vector spacing with respect to one another. The term “vector spacing” means a distance between adjacent, preferably uninterrupted, scan vectors, which is determined in a direction perpendicular to the position of the scan vectors in the same plane (as opposed to a distance to scan vectors in an adjacent strip or box or in other solidification regions). For solidification tracks, the vector spacing would correspond to the distance between the centres of two adjacent solidification tracks. It should be noted here that with interrupted hatching, e.g. in the case of holes within an otherwise flatly extended hatching, the hole with its surrounding filling pattern is treated as another filling region. The surrounding filling region then has an uninterrupted hatching. However, hatchings can also be interrupted, at least as long as the scan vectors are still parallel to each other.

When selecting the first filling region, this must have a filling pattern of scan vectors that are parallel to one another. The first solidification region can for example, correspond to the lowest component layer, but also to any other component layer, but not the uppermost one, since otherwise the subsequent process steps can no longer be carried out.

The first filling region can also be generated from layer information in the form of geometric data. This process is prior art, well known to those skilled in the art and is used, for example, if the layer information already has filling regions or filling patterns.

It should be noted in general that the method always requires an initial filling pattern in order to be able to determine and arrange the subsequent filling patterns located thereabove. It is fundamentally irrelevant whether this filling pattern is already initially present in the layer information or is only generated from it.

Two filling regions are now arranged in (directly) superimposed solidification regions in such a way that the filling patterns are substantially parallel to each other (and thus not rotated relative to each other as in the prior art). In this case, the entire filling region could be slightly shifted or also the filling pattern within the filling region.

Like the first filling region, the second filling region also has a filling pattern of scan vectors that are parallel to each other. The scan vectors of the second filling region are not only aligned substantially parallel to the scan vectors of the first filling region, but are also offset with respect to these. This preferably means a lateral shift, which then results in an interlocking of the resulting solidification tracks during manufacture. However, it can also be the case that there is a longitudinal offset between adjacent strips of a hatching, so that strips lying on top of each other overlap. The first and second filling regions are naturally located on top of each other, although the edges may indeed be slightly shifted with respect to one another due to the offset.

The final generation of control data corresponds to the procedure known in the prior art. Basically, the scan vectors are translated into control commands that the manufacturing device in question understands, e.g. G-code. The special feature of the generated control data consists in that component layers can be produced according to the specially arranged solidification regions with superimposed filling patterns according to the invention.

It should be noted that the method is particularly advantageous if the steps of the method are applied to the arrangement of the filling regions for a plurality of solidification regions (for creating component layers), so that two or more solidification regions are produced with filling patterns offset according to the invention and then two or more solidification regions are produced with filling patterns offset according to the invention which are rotated relative to those located thereunder (i.e. basically steps b) and c)) are repeated with the filling patterns rotated in each case.

The method described above can be used to generate control data according to the invention which are used to control a device for additive manufacturing. As stated, these control data are characterized by the fact that scan vectors of solidification regions located directly above one another are arranged substantially parallel and offset to one another. During manufacture, component layers are generated using these control data, which are characterized by the fact that solidification tracks of component layers lying directly on top of one another are arranged substantially parallel and offset with respect to one another.

This suppresses pores within a component so that the size and/or number of pores is smaller than in conventional components that were manufactured only with twisted filling patterns.

The control data also preferably comprises further design instructions such as: layer application of building material and in particular the lowering of the building platform between the manufacture of the component layers. This is implicitly the case with an arrangement of two component layers, since a new component layer can only be applied to an already solidified region by application of new building material. Due to this application it is usually necessary to lower the building platform.

In a manufacturing process according to the invention for the additive manufacturing of a component, the component is constructed in layers in a construction field in the form of component layers by selective solidification of building material, preferably comprising a metal-based powder, by irradiation of the building material with at least one energy beam according to the control data according to the invention. To create component layers of the component, the energy beam is moved across the construction field according to the control data, i.e. along the scan vectors contained in the control data and thus in the form of the specified filling patterns.

A control data generation device according to the invention serves to generate control data according to the invention (according to the method according to the invention) for a device for the additive manufacturing of a component in a manufacturing process in which the component is built up in a construction field in the form of component layers by selective solidification of building material, preferably comprising a metal-based powder, by irradiating the building material with at least one energy beam.

The control data generation device comprises the following components:
a data interface designed to receive layer information comprising geometric parameters of component layers and/or information on scan vectors of solidification regions which represent component layers of the component,
a control module designed for
i) selecting or generating a first filling region for a first solidification region, wherein this filling region has a filling pattern of scan vectors parallel to one another with a predefined vector spacing,
ii) creating a second filling region with a filling pattern of scan vectors parallel to one another for a second solidification region lying on the first solidification region, wherein the scan vectors of the second filling region are aligned substantially, preferably exactly, parallel to the scan vectors of the first filling region and are arranged offset relative thereto,
a control data generation unit designed to generate control data in such a way that the device for additive manufacturing can use these control data to produce component layers corresponding to the solidification regions.

A control device according to the invention serves a device for the additive manufacturing of a component in a manufacturing process in which the component is constructed in layers in a construction field in the form of component layers by selective solidification of building material, preferably comprising a metal-based powder, by irradiating the building material with at least one energy beam by means of an irradiation device. The control device is designed to control the device for additive manufacturing of the component layers of the component according to control data according to the invention. Preferably, the control device according to the invention comprises a control data generation device according to the invention.

A device according to the invention (“manufacturing device”) is used for the additive manufacturing of at least one component in an additive manufacturing process. This comprises at least
a feeding device for applying layers of building material to a construction field in a process room,
an irradiation device for selectively solidifying building material by irradiation with at least one energy beam, in particular between the application of two material layers, and
a control device according to the invention.

It should be noted at this point that the device according to the invention can also have several irradiation devices, which are then controlled accordingly in a coordinated manner using the control data, as mentioned above. It should also be mentioned again that the energy beam can also consist of several superimposed energy beams or that the energy beam can comprise both particle radiation and electromagnetic radiation, such as light or preferably laser radiation.

The invention can be implemented in particular in the form of a computer unit, in particular in a control device, with suitable software. This means in particular the creation of control data, since the manufacture of a component takes place using further components. The computer unit can, for example, have one or more cooperating microprocessors or the like for this purpose. In particular, it can be implemented in the form of suitable software program parts in the computer unit. A largely software-based implementation has the advantage that previously used computer units, in particular in control devices of manufacturing devices, can also be easily retrofitted by a software or firmware update to work in the manner according to the invention. In this respect, the object is also solved by a corresponding computer program product with a computer program, which can be loaded directly into a memory device of a computer unit, with program sections to carry out all steps of the method according to the invention (at least those which relate to the generation of control data, but possibly also those which serve to transmit the control data for a manufacturing process) when the program is executed in the computer unit. Such a computer program product may, in addition to the computer program, optionally comprise additional components such as documentation and/or additional components, including hardware components, such as hardware keys (dongles, etc.) for using the software. A computer-readable medium, such as a memory stick, a hard disk or another portable or permanently installed data carrier, on which the program sections of the computer program that can be read and executed by a computer unit are stored, can be used for transport to the computer unit and/or for storage on or in the computer unit.

Further, particularly advantageous embodiments and further developments of the invention are obtained from the dependent claims and the following description, whereby the independent claims of one claim category can also be further developed analogously to the dependent claims and exemplary embodiments of another claim category and in particular also individual features of different exemplary embodiments or variants can be combined to form new exemplary embodiments or variants.

A preferred method comprises the following step after step c) and before step d) (i.e. after the parallel and offset arrangement of scan vectors and before the generation of control data):
creating a third filling region from scan vectors parallel to one another for a third solidification region, wherein the third filling region lies above the first filling region (in particular directly above the second filling region) and at least partially covers it, and wherein the filling pattern of the third filling region is twisted with respect to the filling pattern of the first filling region (and thus also with respect to the filling pattern of the second filling region), in particular by a rotation angle of more than 10°, preferably wherein the filling pattern of the third filling region is (geometrically) identical to the filling pattern of the first filling region except for the twisting of scan vectors. The global extent of the filling regions could vary considerably, since the geometry of a component can change from layer to layer.

It should be noted that the third filling region does not necessarily have to lie on the second filling region, but that additional filling regions can be located between the second filling region and the third filling region, which have a parallel and offset arrangement of scan vectors relative to the first filling region. However, the third filling region must lie above the first filling region, which means that its projection along the surface normal of the solidification region lies substantially (at least 80%) on the first surface region.

The preceding step is particularly preferably followed by a step corresponding to step c):
creating a fourth filling region from scan vectors parallel to one another for a fourth solidification region resting on the third solidification region, wherein the scan vectors of the fourth filling region are aligned substantially parallel to the scan vectors of the third filling region and arranged offset from them.

It is particularly preferred that after a rotation the number of layers in which offset filling patterns according to the invention are provided corresponds to the number of layers located thereunder, i.e. for example, always two, three or more solidification regions directly above one another with offset filling patterns (with parallel scan vectors) are provided, then the filling patterns are rotated and again two, three or more solidification regions directly above one another with offset filling patterns (with scan vectors parallel to one another) are provided.

It should be noted here that the terms “first”, “second”, “third” and “fourth” merely serve to better differentiate and do not exclude the possibility that further component layers with filling patterns offset according to the invention could be located between the solidification regions two and three.

According to a preferred method, the scan vectors of the second filling region in a plane of the second solidification region are shifted with respect to the scan vectors of the first filling region in a transverse direction relative to a longitudinal extension of the scan vectors of the first filling region. This means that, when viewed from above, they lie in intermediate spaces between two underlying scan vectors. Preferably, the corresponding vector spacings of the filling patterns of the filling regions are identical.

In this case, it is preferred that a shift distance in the transverse direction is smaller than the vector spacing between two scan vectors. Preferably, this shift distance is in the range between 90% and 10% of the vector spacing and particularly preferably in the range between 45% and 55% of the vector spacing. It is particularly preferred that the shift distance is greater than 10% of the vector spacing, in particular greater than 20%, in particular greater than 30%, in particular greater than 40%. On the other hand, it is particularly preferred that the shift distance is less than 90% of the vector spacing, in particular less than 80%, in particular less than 70%, in particular less than 60%. For example, the scan vectors of the offset filling pattern in question are located precisely in the middle (50% of the vector spacing) between the scan vectors of the filling pattern located immediately below. If filling patterns are located parallel above one another in precisely three solidification regions directly above one another, it may also be preferable that the scan vectors are each shifted by ⅓ of the vector spacing with respect to one another. In absolute terms, an offset is preferably less than 0.2 mm, particularly preferably less than 0.1 mm, at least for conventional scan vectors.

As stated above, at least some of the filling patterns have scan vectors parallel to each other with a predefined vector spacing. In this regard, a preferred filling pattern is formed from a hatching comprising a plurality of scan vectors parallel to one another. Alternatively, a preferred filling pattern is formed from a contour of scan vectors parallel to one another, whereby this means an edge region of the solidification region which is formed from two or more scan vectors. Alternatively, a preferred filling pattern is formed from a circular or spiral arrangement of a number of scan vectors. Basically, it is only important that scan vectors run parallel to each other so that an offset can be achieved in filling regions located directly above one another.

It is preferred that in superimposed solidification regions, filling regions substantially cover each other over their entire surface. In this case, filling regions with an identical shape and size preferably overlap each other substantially over their entire surface. The term “substantially” means that at least 80%, in particular at least 90%, of the surfaces overlap each other. It should be noted here that the filling patterns within the filling regions are preferably shifted with respect to one other in order to achieve the required offset of the scan vectors.

Alternatively or additionally (possibly at another location in the solidification regions), filling regions are preferably arranged offset with respect to one another, preferably with filling regions having a similar or identical filling pattern being offset with respect to one another along the scan vectors by a predetermined shift distance.

Alternatively or additionally (possibly at another location in the solidification regions), filling regions are arranged twisted with respect to each other without their filling patterns being twisted. This means, for example, for rectangular filling regions, that the sides of the filling regions are twisted with respect to each other, but the scan vectors of these superimposed filling regions are not twisted with respect to each other and still run parallel (and offset) to each other.

Alternatively or additionally (possibly at another location in the solidification regions), filling patterns of overlapping filling regions differ from each other with respect to an offset along and/or transverse to their scan vectors, and/or with respect to a rotation of their scan vectors.

It is preferable that a shift distance in the longitudinal direction is less than a stripe width (standard length or maximum length of the respective scan vectors) of a filling region in the form of a hatch stripe. The shift distance is preferably in the range between 90% and 10% of the stripe width, and particularly preferably in the range between 45% and 55% of the stripe width. It is particularly preferred that the shift distance is greater than 10% of the stripe width, in particular greater than 20%, in particular greater than 30%, in particular greater than 40%. On the other hand, it is particularly preferred that the shift distance is less than 90% of the stripe width, in particular less than 80%, in particular less than 70%, in particular less than 60%. In contrast to the transverse offset described in more detail above, a longitudinal offset is described here, which is possible as an alternative or in addition to the transverse offset and improves the stability as well as the quality (with regard to the homogeneity of the microstructure) of a component.

Particularly preferably, a shift therefore takes place in the transverse direction and in the longitudinal direction, wherein the shift distance is in particular smaller than a diagonal extension of the first filling region. The shift distance is preferably in the range between 90% and 10% of the diagonal extension, and particularly preferably in the range between 45% and 55% of the diagonal extension. It is particularly preferred that the shift distance is greater than 10% of the diagonal extension, in particular greater than 20%, in particular greater than 30%, in particular greater than 40%. On the other hand, it is particularly preferred that the shift distance is less than 90% of the diagonal extension, in particular less than 80%, in particular less than 70%, in particular less than 60%.

According to a preferred method, within a filling region and/or between two filling regions located directly above one another, the values of a number of parameters of the energy beam for solidifying a building material are changed during solidification along the scan vectors. These parameters are in particular a speed (with which the energy beam is guided along a scan vector over the building material), a power, a pulse pattern and/or an intensity distribution. In particular, the respective values of the number of parameters change between the first filling region and the second filling region and/or the third filling region and the fourth filling region. Here, (especially parallel and offset) scan vectors of filling regions located directly above each other are provided with different parameters of the energy beam for the control data.

According to a preferred method, the control data are generated such that the energy beam is adjusted so that it solidifies a region deeper than the thickness of the last component layer when solidifying along the scan vectors. This depth of solidification is preferably at least twice, more preferably at least three times, particularly preferably at least four times the thickness of the respectively last component layer. Particularly preferably, a solidification has a depth extension greater than 0.05 mm, in particular greater than 100 μm and/or less than 300 μm.

Preferably, solidification takes place in the form of a deep welding process. Deep welding is considered to be a process when a vapour capillary forms, also called a “keyhole”. The incoming energy beam creates a lake of molten material. When the lake surface of the material reaches its boiling temperature, the resulting vapour bubble pushes the melt sideways and downwards and thus creates the vapour capillary. The diameter of this keyhole is smaller than that of the energy beam or laser beam. The vapour capillary also forms depending on the speed of movement of the energy beam, in the case of a laser typically from an intensity of 2 MW/cm² at 1 m/min. The deeper the keyhole becomes, the greater the forces that then try to collapse it and the more power of the energy beam has already been absorbed, so that an equilibrium is finally established at a certain depth that depends on certain parameters. As a result of the formation of the vapour capillary on the surface of the building material, the jet bundle penetrates deeper beneath the surface of the layer to be solidified. This can lead to a multiple reflection of the beam, by means of which radiation absorption is formed. When forming solidification tracks, a deep welding process is preferably used. The speed should be selected so that the weld seam is stable and no humping occurs.

As already mentioned above, a particular advantage of the invention is the reduction of porosity in a component. The number and the size of pores should be small for a high quality of the component. From the size G and/or the number A of pores, a certain comparative measure V can also be derived, e.g. with the weighting values a, b, c, d according to the formula V=aR+bG+cGR+d. The values for the size G and/or the number A of pores can be given in the form of parameter values, e.g. as a vector or value field (G, A). It should be noted that the “comparative measure” does not specify a ratio of a comparison, but represents a measure for a comparison. Using their respective comparative measures, two components can then be compared with each other and a “quality measure” can be determined as a comparison value, e.g. in the form of a difference or a quotient of their comparative measures. For example, a standard comparative measure can be used and this can be compared with a comparative measure of a test body. The deviation of the comparative measure from the standard comparative measure (the quality measure) then gives the quality of the test body.

The layer information that is initially made available to the process can include predefined vector spacings of the scan vectors and usually predefined scan speeds. Prior knowledge about improving the quality of the invention could be incorporated into this layer information in advance and as a result, faster manufacture could be achieved. However, the method could also modify predefined vector spacings of the scan vectors or scan speeds in provided layer information or generate new (possibly modified) layer information in order to achieve an increase in process efficiency whilst maintaining the same quality (compared to a manufacture without application of the method according to the invention).

According to a preferred method, a quality measure is determined from a comparison of pores of test specimens. This method comprises the following steps:
manufacturing a target test body with control data which have been created using a method according to one of the preceding claims,
manufacturing a reference test body with control data at least without an offset arrangement of scan vectors according to step c) of the method (according to the invention),
determining parameter values for parameters of pores of the target test body and the reference test body using the same measuring method, wherein the parameter values of the pores comprise in particular their size and/or their number,
creating a comparative measure of the determined parameter values of the target test body and the reference test body,
optional: manufacturing experimental test bodies with control data using a method according to one of the preceding claims, wherein the layer information is modified or generated such that a vector spacing between scan vectors of the filling regions and/or a scanning speed for these scan vectors is increased and
optional: investigating changes in the comparative measure by comparing the test bodies with the reference test body in relation to the layer information, e.g. the modifications of the layer information and creation of a comparative measure, depending on the layer information, e.g. the modifications of the layer information,
creating the quality measure based on a number of created comparative measures.

As mentioned, the quality measure is a measure that indicates a comparison of the quality of a test body. The reference test body represents the reference for the quality (and provides the “standard comparative measure” mentioned above). The quality is derived from the comparative measures, i.e. the pores. The larger and more frequent the pores are, the worse the quality. Basically, the quality measure can be derived directly from a comparative measure or from a comparison of pore values, e.g. according to the above formula P=aR+bG+cGR+d with the comparative measure of the reference test body.

The target test body is manufactured with filling regions offset according to the invention and the reference test body with successively twisted filling regions. The (optional) test bodies are manufactured according to the target test bodies, but with varied scanning speed or varied vector spacing. Basically, the scanning speed for different test specimens can simply be increased successively or the vector spacing can be increased successively.

The comparative measure can simply be a ratio or a difference of the parameter values of the target test body (or reference test bodies) and the reference test body. However, it can also contain mixed values from G·A.

In principle, a single target test body is sufficient, at least if there is sufficient theoretical knowledge by means of which a quality measure can be derived from the measurements on this test body. However, more accurate results can be achieved using experimental test bodies, since these were manufactured specifically using different manufacturing parameters. Basically, it is now sufficient to determine the manufacturing parameters (scanning speed or vector spacing) used to manufacture an experimental test body which has the quality of the reference test body (or a better quality).

Preferably, based on the quality measure, the obtained or generated layer information is modified by increasing the vector spacing of scan vectors of the filling regions with respect to one another and/or by increasing the scanning speed for these scan vectors, and the steps of the method are carried out based on the modified or generated layer information. Preferably, the scanning speed is increased or the vector spacing is increased. As a result, the quality of a manufactured component is reduced but its manufacture can be speeded at the expense of quality. If the quality of the component is to be the same as that of a conventionally manufactured component, its manufacture can be accelerated. However, manufacture can also be accelerated just a little and a component of better quality can be produced. The desired quality is predefined by the quality measure.

The quality measure comprises in particular information about a relationship to modifications of the layer information, i.e. information about the extent to which the vector spacing and/or the scanning speed have been changed.

The invention is explained in more detail below with reference to the attached figures using embodiments. In the different figures, identical components are provided with identical reference numbers. In the figures:

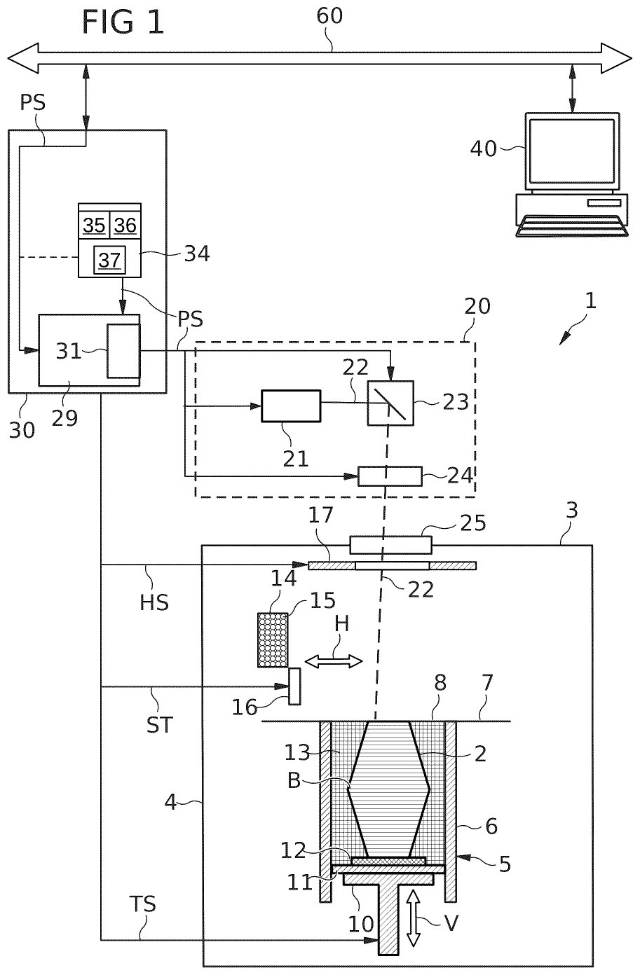

FIG. 1 shows a schematic view, depicted partially in section, of an exemplary embodiment of a device for additive manufacturing,

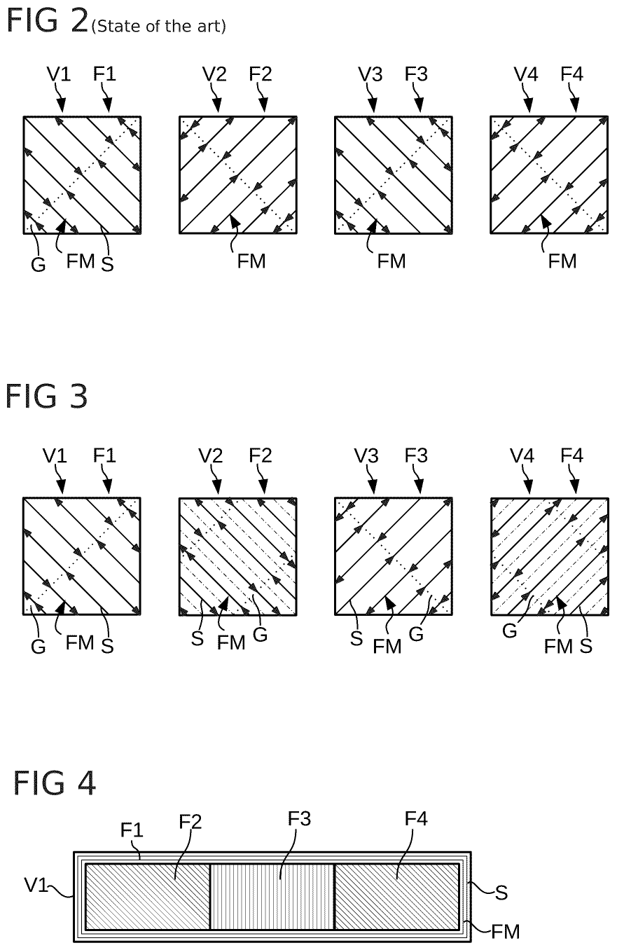

FIG. 2 shows a design of filling regions of different solidification regions with filling patterns according to the prior art,

FIG. 3 shows a design of filling regions of different solidification regions with filling patterns according to an exemplary embodiment of the invention,

FIG. 4 shows an example for a solidification region with different filling regions,

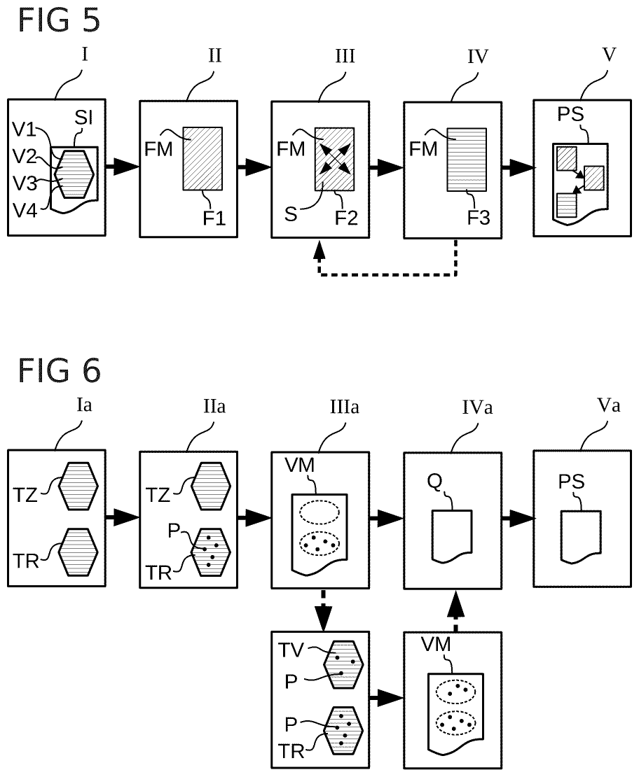

FIG. 5 shows a block diagram of a possible process sequence of an exemplary embodiment of a method according to the invention,

FIG. 6 shows a block diagram of a possible process sequence of an exemplary embodiment of a method according to the invention for increasing the process speed.

The following exemplary embodiments are described with reference to a device 1 for the additive manufacturing of components in the form of a selective laser sintering or laser melting device, wherein it is explicitly pointed out again that the invention is not limited to selective laser sintering or laser melting devices. The device is therefore referred to hereinafter-without any restriction of the generality—as “manufacturing device” 1 for short.

Such a manufacturing device 1 is shown schematically in FIG. 1. The device has a process chamber 3 or a process space 3 with a chamber wall 4, in which the manufacturing process substantially takes place. Located in the process chamber 3 is a container 5 which is open at the top and has a container wall 6. The upper opening of the container 5 forms the respectively current working plane 7. The region of this working plane 7 located within the opening of the container 5 can be used to construct the object 2 and is therefore referred to as the construction field 8.

The container 5 has a base plate 11 which is movable in a vertical direction V which is arranged on a carrier 10. This base plate 11 terminates the container 5 downwards and thus forms its base. The base plate 11 can be formed integrally with the carrier 10, but it can also be a plate formed separately from the carrier 10 and fastened to the carrier 10 or simply mounted thereon. Depending on the type of specific building material, for example the powder used, and the manufacturing process, a building platform 12 can be attached to the base plate 11 as a building substrate on which the object 2 is constructed. In principle however, the object 2 can also be constructed on the base plate 11 itself, which then forms the building substrate.

The fundamental construction of the object 2 is accomplished by applying a layer of building material 13 initially to the building platform 12, then—as is explained subsequently—the building material 13 is selectively solidified using a laser beam 22 as an energy beam at the points which are to form parts of the object 2 to be manufactured, then with the aid of the carrier 10 the base plate 11, therefore the building platform 12, is lowered and a new layer of the building material 13 is applied and selectively solidified, etc. In FIG. 1, the object 2 constructed in the container on the building platform 12 is shown below the working plane 7 in an intermediate state. Said object already has a plurality of solidified layers, surrounded by building material 13 that has remained unsolidified. Various materials can be used as the building material 13, preferably powder, in particular metal powder, plastic powder, ceramic powder, sand, filled or mixed powders or also pasty materials and optionally a mixture of several materials.

Fresh building material 15 is located in a storage container 14 of the manufacturing device 1. With the aid of a layering device 16 which can be moved in a horizontal direction H, the building material can be applied in the form of a thin layer in the working plane 7 or within the construction field 8.

Optionally, an additional radiation heater 17 is located in the process chamber 3. This can be used to heat the applied building material 13 so that the irradiation device used for the selective solidification does not have to introduce too much energy. This means that, for example, with the aid of the radiation heater 17, a quantity of basic energy can be introduced into the building material 13, which is naturally still below the energy required for the building material 13 to fuse or sinter. An infrared radiator or VCSEL radiator, for example, can be used as radiation heater 17.

For selective solidification, the manufacturing device 1 has an irradiation device 20 or, more specifically, an exposure device 20 with a laser 21. This laser 21 generates a laser beam 22, which is deflected by a deflection device 23 in order to trace the scan vectors S provided according to the exposure strategy in the layer to be selectively solidified and to selectively introduce the energy. Furthermore, this laser beam 22 is focused in a suitable manner onto the working plane 7 by a focusing device 24. The irradiation device 20 is preferably located outside the process chamber 3 and the laser beam 22 is guided into the process chamber 3 via a coupling window 25 attached to the top of the process chamber 3 in the chamber wall 4.

The irradiation device 20 can, for example, comprise not only one but several lasers. Preferably, these can be gas or solid-state lasers or any other type of laser such as laser diodes, in particular VCSEL (Vertical Cavity Surface Emitting Laser) or VECSEL (Vertical External Cavity Surface Emitting Laser) or a row of these lasers. Quite particularly preferably, within the scope of the invention, one or more unpolarized single-mode lasers, e.g. a 3 KW fibre laser with a wavelength of 1070 nm can be used.

A control device 30 comprising a control unit 29 is used to control the units of the manufacturing device 1, which controls the components of the irradiation device 20, namely here the laser 21, the deflection device 23 and the focusing device 24, and for this purpose accordingly transfers process control data PS to them.

The control unit 29 also controls the radiation heater 17 by means of suitable heating control data HS, the layering device 16 by means of layering control data ST and the movement of the carrier 10 by means of carrier control data TS and thus controls the layer thickness.

The control device 30 is, here, for example, via a bus 60 or another data connection, coupled to a terminal 40 with a display or the like. Via this terminal 40, an operator can control the control device 30 and thus the entire laser sintering device 1, e.g. by transmitting process control data PS.

In order to optimize the production process, the control data PS are generated or modified in the manner according to the invention by means of a control data generation device 34 such that the control of the device 1 takes place at least temporarily in a mode according to the invention.

The control data generation device 34 here comprises a data interface 35 for receiving layer information SI for a component 2. This layer information SI already includes, for example, layer structures of the component (the solidification regions V1, V2, V3, V4, see following figures). Alternatively, the control data generation device 34 comprises a cutting unit 35 designed to generate this layer information SI. Surfaces of the layer structures are to be solidified with a predefined filling pattern F (see also the following figures for the functions of the components).

In this example, the layer information SI contains data about solidification regions V1, V2, V3, V4, which represent component layers B of the component 2, wherein the solidification regions V1, V2, V3, V4 are formed from a number of filling regions F1, F2, F3, F4. Furthermore, the layer information SI comprises data on scan vectors S, according to which the filling regions F1, F2, F3, F4 are to be solidified. The scan vectors S form a predefined filling pattern FM in each filling region F1, F2, F3, F4, wherein at least some of the filling patterns FM have scan vectors S parallel to one another with a predefined vector spacing. It should be noted here that the layer information SI does not yet represent finished component layers B, since the latter are only created using the layer information SI. The solidification regions V1, V2, V3, V4 are therefore not solidified regions, but usually represent a plurality of filling regions F1, F2, F3, F4, wherein each filling region in turn usually comprises a plurality of scan vectors S, which are arranged in the form of a filling pattern (frequently in the form of hatchings). If an energy beam 22 is guided along these scan vectors S over a layer of building material 13, the building material 13 is solidified there in the form of solidification tracks with the corresponding filling patterns F1, F2, F3, F4. Therefore, the solidification regions V1, V2, V3, V4 represent the component layers B, the scan vectors S represent the solidification tracks of the component layers B and the filling regions F1, F2, F3, F4 represent individual regions of the component layers B with a uniform filling pattern FM.

In addition to the data interface 35, the control data generation device 34 comprises a control module 36. This control module 36 is designed to select a first filling region F1 for a first solidification region V1 and then to create a second filling region F2 for a second solidification region V2 lying on the first solidification region V1. Each filling region F1, F2 has a filling pattern FM made up of parallel scan vectors S. However, the control module can also be designed to generate the first filling region F1 (and also further filling regions) of the first solidification region V1, in particular in the case that the layer information SI exclusively comprises geometric data relating to the component 2.

It is important here that the scan vectors S of the second filling region F2 are aligned substantially (preferably exactly) parallel to the scan vectors S of the first filling region F1 and arranged offset from them. This means that subsequently the solidification tracks in the resulting component layers B do not run twisted with respect to one another, but parallel and offset with respect to one another. Only when at least two solidification regions V1, V2 have such “untwisted” filling regions F1, F2, a rotation of filling regions F3, F4 or their filling patterns FM can be carried out, wherein here too it is preferred to provide at least two solidification regions V3, V4 with “untwisted” filling regions F3, F4 with respect to one another after one rotation and before the next rotation, which can be carried forward over the entire height of the component.

Furthermore, the control data generation device 34 comprises a control data generation unit 37, which is designed to generate control data PS and specifically in such a way that the device 1 for additive manufacturing can produce component layers B corresponding to the solidification regions V1, V2, V3, V4 using this control data.

In a particularly preferred variant, the control data generation device 34 is implemented on an external computer unit, for example the terminal 40, and already supplies process control data PS in advance with correspondingly suitable control data PS, with which the device 1 is controlled such that the intended mode is achieved in the desired regions of the component. In this case, the internal control data generation device 34 present in the control device 30 could also be dispensed with.

It is also pointed out again at this point, that the present invention is not limited to such a manufacturing device 1. It can be applied to other processes for the generative or additive production of a three-dimensional object by layer-by-layer application and selective solidification of a building material, wherein an energy beam is emitted to solidify the building material to be solidified. Accordingly, the irradiation device may not only be a laser as described here, but any device could be used by means of which energy as wave or particle radiation can be selectively brought onto or into the building material. For example, instead of a laser, another light source, an electron beam, etc. could be used.

Even if FIG. 1 only shows a single object 2 or component 2, it is possible and usually also usual to produce several objects in parallel in the process chamber 3 or in the container 5. For this purpose, the building material is scanned layer by layer by the energy beam 22 at locations that correspond to the cross-sections of the objects in the respective layer.

FIGS. 2 and 3 show a design of filling regions F1, F2, F3, F4 of different solidification regions V1, V2, V3, V4 with filling patterns FM. The solidification regions V1, V2, V3, V4 are located directly above one another and would result in four consecutive component layers B during manufacture. Each filling pattern FM is a hatching (also designated as “hatching”) of scan vectors S with the same vector spacing. The scan vectors S are not continuous, but form stripes that meet at stripe boundaries G (indicated by dotted lines) and slightly overlap each other.

FIG. 2 shows a design according to the prior art. From left to right, a first filling region F1 in a first solidification region V1 is covered by a second filling region F2 in a second solidification region V2 with a rotated filling pattern FM. This is followed by a third and fourth solidification region V3, V3 with further rotated filling patterns FM in the corresponding filling regions F3, F4. The rotation in this example is 90° and in practice can basically take on any angle.

FIG. 3 shows a design according to an exemplary embodiment of the invention. In contrast to the prior art, a rotation does not take place here between each solidification region V1, V2, V3, V4, but only after every second one. From left to right, a first filling region F1 in a first solidification region V1 is covered by a second filling region F2 in a second solidification region V2 with a non-rotated filling pattern FM. Rather, the filling patterns FM overlap each other offset with respect to one other, wherein in the second filling region F2 the underlying scan vectors S of the first filling region F1 are indicated by dash-dot lines. In this example, the offset is accomplished both transversely to the longitudinal direction of the scan vectors S and longitudinally across stripe boundaries G. After a rotation of the filling pattern in the third solidification region V4, an offset alignment of the filling pattern FM is again accomplished in the fourth solidification region V4.

It should be noted that here the filling patterns FM have been rotated within filling regions F1, F2, F3, F4. It is also possible that the filling regions F1, F2, F3, F4 are rotated together with their filling pattern FM.

FIG. 4 shows an example of a solidification region V1 with different filling regions F1, F2, F3, F4. Three inner filling regions F2, F3, F4, which are arranged in a checkerboard pattern with different filling patterns FM, are surrounded by a filling region F1, which reproduces the contour or edge of the solidification region V1. Whilst the filling patterns FM in the inner region are hatchings, the scan vectors S of the filling pattern FM of the outer filling region F1 run parallel to each other around the inner region.

FIG. 5 shows a block diagram of a possible process sequence of an exemplary embodiment of a method according to the invention for generating control data PS for a device 1 for the additive manufacturing of a component 2 in a manufacturing process in which the component 2 is constructed in a construction field 8 in the form of component layers B by selective solidification of building material 13, e.g. comprising a metal-based powder, by irradiating the building material 13 with at least one energy beam 22.

In step I, layer information SI about solidification regions V1, V2, V3, V4 is generated or obtained. The solidification regions V1, V2, V3, V4 represent component layers B of component 2 and are each formed from a plurality of filling regions F1, F2, F3, F4. The layer information SI comprises data on scan vectors S, according to which the filling regions F1, F2, F3, F4 are to be solidified, wherein the scan vectors S form a predefined filling pattern FM in each filling region F1, F2, F3, F4 and at least some of the filling patterns FM have scan vectors S that are parallel to one another and have a predefined vector spacing (see, for example, FIG. 2).

The layer information may well be control data according to the prior art, which are modified by the method into control data PS according to the invention. However, they can also only comprise geometric data of the component 2 or its component layers.

In step II, a first filling region F1 with a filling pattern FM consisting of scan vectors S parallel to one another is selected or generated for a first solidification region V1. The selection or generation can extend successively to further filling regions F2, F3, F4 and theoretically relate to all the filling regions F1, F2, F3, F4 of the solidification region V1, in which case the subsequent steps are then also carried out for the filling regions F1, F2, F3, F4 of the solidification regions V2, V3, V4 located thereabove, either separately from one another or parallel to one another. Thus, the following explanations can also extend to other filling regions F2, F3, F4, but for a better overview they are only continued here using the example of a filling region F2. This step could involve the selection of the left filling region F1 of FIG. 3.

In step III, there is a second filling region F2 with a filling pattern FM of scan vectors S parallel to one another for a second solidification region V2 lying on the first solidification region V1, wherein the scan vectors S of the second filling region F2 are aligned substantially parallel to the scan vectors S of the first filling region F1 and are arranged offset with respect to these. The arrows in the corresponding box indicate that the offset can be accomplished transversely and/or longitudinally to the longitudinal direction of the scan vectors S. The offset can, for example, be precisely half of a vector spacing of scan vectors S. This step could result in the second filling region F2 from the left in FIG. 3.

In step IV, a third filling region F3 is created from scan vectors S parallel to one another for a third solidification region V3. This third filling region F3 lies above the first filling region F1 and covers it. The filling pattern FM of the third filling region F3 is twisted with respect to the filling pattern FM of the first filling region V3. This step could result in the third filling region F2 from the left in FIG. 3.

The dashed arrow pointing back to step III indicates that this procedure (parallel arrangement, then rotation) can be repeated as desired.

In step V, control data PS are then generated in such a way that the device 1 for additive manufacturing can produce component layers B corresponding to the solidification regions V1, V2, V3, V4 using this control data PS.

This process provides control data PS, by means of which components 2 with a very low porosity and thus very high component quality can be produced. However, it can be desirable that the component quality should not be increased because it is already sufficient. In this case, the method can be modified so that when generating the control data PS, the scanning speed and/or the vector spacing of the scan vectors S is increased and thus the manufacturing time is reduced. Although this does impair the quality of the components, due to the higher quality achieved by the process it is within the tolerable range or within the desired range.

FIG. 6 shows a block diagram of a possible process sequence of an exemplary embodiment of a method according to the invention for increasing the process speed. In this method, a quality measure is first determined from a comparison of pores of test bodies and then the control data PS are modified accordingly.

In step Ia, a target test body TZ with control data PS from a method according to the invention and a reference test body TR with conventional control data PS (without an offset arrangement of scan vectors S according to step III of the method) are manufactured.

In step IIA, parameter values for parameters of pores P of the target test body TZ and the reference test body TR are determined using the same measuring method, wherein the parameter values of the pores P comprise in particular their size and/or their number.

In step Illa, a comparative measure VM of the determined parameter values of the target test body TZ and the reference test body TR is created, e.g. a ratio of the sizes or the number of pores P.

Optional steps are indicated below with dashed arrows in which experimental test bodies TV were produced with control data PS according to the invention, in which the layer information SI was modified such that a vector spacing of scan vectors S of the filling regions F1, F2, F3, F4 with respect to one another and/or a scan speed for these scan vectors S is increased. In this example a modification of layer information is assumed. The layer information can also be generated, wherein the following comparisons with the original and the generated layer information are carried out analogously.

Based on these experimental test bodies TV, the comparative measure VM is now again determined in comparison with the reference test body TR, but this time in relation to the modifications of the layer information SI.

In step IVa, the quality measure Q is then determined based on at least one comparative measure VM. This can be the comparative measure from step Illa or comparative measures from the optional steps.

In step Va, control data PS are then generated based on the quality measure Q, so that the device 1 for additive manufacturing can produce component layers B using these control data PS. In this example, the scanning speed and/or the vector spacing between two scanning vectors S are dimensioned in such a way that a predefined component quality is not fallen below, wherein the quality measure Q indicates whether the expected component quality is still within a tolerable range or not.

In a simple case, in the aforementioned optional steps using the comparative measure VM it can easily be estimated whether the quality of an experimental test body TV corresponds to the quality of the reference test body TR and precisely the parameters for the control data PS are selected that were available during the manufacture of this test body TV.

Finally, it is pointed out once again that the devices described in detail hereinbefore are merely exemplary embodiments which can be modified in various ways by a person skilled in the art without departing from the scope of the invention. For example, a solidification could be achieved using other energy beams instead of laser light. Furthermore, the use of the indefinite articles “a” or “an” does not exclude the possibility that the features in question may also be present multiple times. Likewise, the term “unit” does not exclude the possibility that it consists of several cooperating subcomponents, which may also be spatially distributed. The expression “a number” shall be understood to mean “at least one”.

### REFERENCE LIST

1 Device for additive manufacturing/manufacturing device
2 Component/object
3 Process room/process chamber
4 Chamber wall
5 Container
6 Container wall
7 Working plane
8 Construction field
10 Carrier
11 Base plate
12 Building platform
13 Building material (in container 5)
14 Storage container
15 Building material (in storage container 14)
16 Layering device
17 Radiation heater
20 Irradiation device/exposure device
21 Laser
22 Laser beam/energy beam
23 Deflection device/scanner
24 Focusing device
25 Coupling window
29 Control unit
30 Control device
31 Irradiation control interface
34 Control data generation device
35 Data interface
36 Control module
37 Control data generation unit
40 Terminal
60 Bus
B Component layer
FM Filling pattern
F1, F2, F3, F4 filling region
G Stripe boundaries
H Horizontal direction
HS Heating control data
P Pore
PS Process control data/control data
Q Quality measure
S Scan vector/hatch line
SB Process room sensor data set/layer image
SDS Process room sensor data
SI Layer information
ST Layering control data
TR Reference test body
TS Carrier control data
TV Test body
TZ Target test body
V Vertical direction
V1, V2, V3, V4 Solidification region
VM Comparative measure

1. A method for generating control data for a device for additive manufacturing of a component in a manufacturing process in which the component is constructed in a construction field in the form of component layers by selective solidification of building material by irradiating the building material with at least one energy beam, the method comprising the steps:
a) obtaining or generating layer information comprising geometric parameters of component layers and/or information relating to scan vectors of solidification regions which represent component layers of the component,
b) selecting or generating a first filling region for a first solidification region, wherein this filling region has a filling pattern of scan vectors parallel to one another with a predefined vector spacing,
c) creating a second filling region having a filling pattern of scan vectors parallel to one another for a second solidification region lying on the first solidification region, wherein the scan vectors of the second filling region are aligned substantially parallel to the scan vectors of the first filling region and arranged offset relative thereto, wherein filling patterns of overlapping filling regions differ from one another with respect to an offset longitudinally and transversely with respect to their scan vectors,
d) generating control data in such a way that the device for additive manufacturing can generate component layers corresponding to the solidification regions using this control data.

2. The method according to claim 1, comprising after step c) and before step d) the steps:
creating a third filling region from scan vectors parallel to one another for a third solidification region, wherein the third filling region lies above the first filling region and at least partially covers it, and wherein the filling pattern of the third filling region is twisted relative to the filling pattern of the first filling region, in by an angle of rotation of more than 10°, wherein the filling pattern of the third filling region is identical to the filling pattern of the first filling region except for the twisting;
creating a fourth filling region from scan vectors parallel to one another for a fourth solidification region lying on the third solidification region, wherein the scan vectors of the fourth filling region are aligned substantially parallel to the scan vectors of the third filling region and arranged offset relative thereto.

3. Method according to claim 1, wherein the scan vectors of the second filling region in a plane of the second solidification region are shifted with respect to the scan vectors of the first filling region in a transverse direction relative to a longitudinal extension of the scan vectors of the first filling region, wherein the corresponding vector spacings of the filling patterns of the filling regions are each identical, wherein a shift distance in the transverse direction is less than the vector spacing between two scan vectors, and lies in the range between 45% and 55% of the vector spacing, and lies below 0.1 mm.

4. The method according to claim 1, wherein a filling pattern is formed of
a hatching consisting of a plurality of scan vectors parallel to one another or
a contour of a plurality of scan vectors parallel to one another or
a circular or a spiral arrangement of a number of scan vectors.

5. The method according to claim 1, wherein in superimposed solidification regions
filling regions substantially cover the entire surface, wherein filling regions with an identical shape and size substantially cover each other entirely, and/or
filling regions are arranged offset with respect to one another, wherein filling regions with a similar or identical filling pattern are shifted with respect to one another along the scan vectors by a predetermined shift distance, and/or
filling regions are arranged twisted with respect to each other without their filling patterns being co-rotated,
and/or
filling patterns of mutually overlapping filling regions differ from one another with respect to an offset along and/or transverse to their scan vectors, and/or with respect to a rotation of their scan vectors,
wherein a shift distance in the longitudinal direction is less than a stripe-width of a filling region in the form of a hatching stripe, and lies in the range between 90% and 10% of the stripe width, and lies in the range between 45% and 55% of the stripe width,
and/or
wherein a shift takes place in the transverse direction, and in the longitudinal direction, the shift distance of which is less than a diagonal extension of the first filling region and lies in the range between 45% and 55% of the diagonal extension.

6. The method according to claim 1, wherein within a filling region and/or between two filling regions lying directly one above each other, the values of a speed, a power, a pulse pattern and/or an intensity distribution, of the energy beam for solidifying a building material are changed during solidification along the scan vectors, wherein the respective values of the number of parameters change between the first filling region and the second filling region and/or the third filling region and the fourth filling region.

7. The method according to claim 1, wherein the control data are generated such that the energy beam is adjusted such that it solidifies an area deeper than the thickness of the respective last component layer during solidification along the scan vectors, at least four times this thickness, and a solidification has a depth extension greater than 0.05 mm, wherein the solidification takes place in the form of a deep welding process.

8. The method according to claim 1, wherein a quality measure is determined from a comparison of pores of test bodies, comprising the steps:
manufacturing a target test body with control data which have been created using a method,
manufacturing a reference test body with control data at least without an offset arrangement of scan vectors according to step c) of the method,
determining parameter values for parameters of pores of the target test body and the reference test body using the same measuring method, wherein the parameter values of the pores comprise in particular their size and/or their number,
creating a comparative measure of the determined parameter values of the target test body and the reference test body,
manufacturing test bodies with control data, wherein layer information is generated or modified such that a vector spacing of scan vectors of the filling regions with respect to one another and/or a scanning speed for these scan vectors is increased and
investigating changes in the comparative measure by comparing the test body with the reference test body in relation to the layer information and creating a comparative measure depending on the layer information,
creating the quality measure based on a number of created comparative measures.

9. The method according to claim 8, wherein based on the quality measure, which comprises information about a relationship to layer information, the obtained or generated layer information is modified by increasing the vector spacing of scan vectors of the filling regions with respect to one another and/or by increasing the scanning speed for these scan vectors, and the steps of the method are carried out based on the modified or generated layer information.

10. The control data for controlling a device for additive manufacturing, which have been generated according to a method according to claim 1.

11. A manufacturing method for the additive manufacturing of a component, wherein in a construction field the component in the form of component layers is constructed in layers by selective solidification of building material, comprising a metal-based powder, by irradiating the building material with at least one energy beam according to the control data according to claim 10, wherein the energy beam is moved over the construction field according to the control data in order to create component layers of the component.

12. The control data generation device for generating control data according to claim 10 for a device for additive manufacturing of a component in a manufacturing process in which the component is constructed in a construction field in the form of component layers by selective solidification of building material, comprising a metal-based powder, by irradiating the building material with at least one energy beam, the control data generation device comprising:
a data interface designed to receive layer information comprising geometric parameters of component layers and/or information relating to scan vectors of solidification regions which represent component layers of the component,
a control module designed for
i) selecting or generating a first filling region for a first solidification region, wherein this filling region has a filling pattern of scan vectors parallel to one another with a predefined vector spacing,
ii) creating a second filling region having a filling pattern of scan vectors parallel to one another for a second solidification region lying on the first solidification region wherein the scan vectors of the second filling region are aligned substantially, parallel to the scan vectors of the first filling region and are arranged offset relative thereto, wherein filling patterns (FM) of overlapping filling regions differ from one another with respect to an offset longitudinally and transversely with respect to their scan vectors;
a control data generation unit designed for generating control data such that the device for additive manufacturing can generate component layers corresponding to the solidification regions using this control data.

13. The control device for a device for additive manufacturing of a component in a manufacturing process in which the component in the form of component layers is constructed layer by layer in a construction field by selective solidification of building material, comprising a metal-based powder, by means of irradiation of the building material with at least one energy beam by means of an irradiation device, wherein the control device is designed to control the device for the additive manufacture of the component layers of the component according to control data according to claim 10, wherein the control device comprises a control data generation device.

14. A device for the additive manufacturing of at least one component in an additive manufacturing process comprising at least
a feeding device for applying material layers of building material to a construction field in a process space,
an irradiation device in order to selectively solidify building material by irradiation with at least one energy beam, in particular between the application of two material layers, and
a control device according to claim 13.

15. A computer program product comprising instructions which, when the program is executed by a computer, cause the computer to carry out the steps of the method according to claim 1.
